(19) United States
(12) Patent Application Publication
(10) Pub. No.: US 2017/0091824 A1
(43) Pub. Date: Mar. 30, 2017

(54) METHOD AND SYSTEM FOR PROVIDING ITEM RECOMMENDATIONS IN A PRIVACY-ENHANCED MANNER

(71) Applicant: THE PROVOST, FELLOWS, FOUNDATION SCHOLARS, AND THE OTHER MEMBERS OF THE BOARD, Dublin (IE)

(72) Inventors: DOUGLAS LEITH, DUBLIN (IE); ALESSANDRO CHECCO, DUBLIN (IE); GIUSEPPE BIANCHI, ROMA (IT)

(21) Appl. No.: 15/268,021

(22) Filed: Sep. 16, 2016

Related U.S. Application Data
(60) Provisional application No. 62/232,959, filed on Sep. 25, 2015.

(51) Int. Cl. G06Q 30/02; G06Q 30/06

(52) U.S. Cl. CPC G06Q 30/0269; G06Q 30/0631

(57) ABSTRACT

A computer-implemented method for providing item recommendations. The method comprises generating a plurality of user groups by a system module and associating each user group with a group identifier; providing the group identifiers to a plurality of user modules for facilitating selection by respective users; selecting at least one group identifier by the respective users indicative of the one or more groups that users desire to be associated with; supplying by the users item preferences using the selected group identifier thereby concealing identities of the users when supplying item preferences; communicating the supplied item preferences with associated selected group identifiers to the system module; and generating a preference matrix by modelling the supplied item preferences and item characteristics.

### RELATED APPLICATIONS

The present invention claims priority from U.S. Provisional Application 62/232,959, filed 25 Sep. 2015, the entirety of which is incorporated herein by reference.

### FIELD OF THE INVENTION

The present disclosure is directed to a method and system for providing item recommendations. In particular, the present disclosure facilitates users concealing their identities when using the recommender system.

### BACKGROUND

A recommender system is an information processing system that predicts the preference or rating that a user would assign to an item. For each user, the recommender system collects information on items that the user likes/dislikes, for example, items which the user has bought or has rated. By comparing this information with the information for other users, the system tries to predict what new items a user may like.

Matrix factorisation is a popular and powerful method for providing recommendations based on sparse user data. The basic idea is to decompose an n×m matrix R containing ratings by n users for a set of m items as U^{T}V where the row dimension d of d×n matrix U and d×m matrix V is much less than n and m. Essentially, this approach “learns” both user preferences and item characteristics, and models them as vectors in a d dimensional feature space.

Most current web recommender systems identify each user uniquely via a cookie or some other identifier stored in their web browser. This approach raises privacy concerns for the user as result of the user being uniquely identified.

There is therefore a need for a recommender system which addresses at least some of the drawbacks of the prior art.

### SUMMARY

According to an aspect of the present disclosure there is provided a computer implemented method for providing item recommendations, the method comprising generating a plurality of user groups by a system module and associating each user group with a group identifier; providing the group identifiers to a plurality of user modules for facilitating selection by respective users; selecting at least one group identifier by the respective users indicative of the one or more groups that users desire to be associated with; supplying by the users item preferences using the selected group identifier thereby concealing identities of the users when supplying item preferences; communicating the supplied item preferences with associated selected group identifiers to the system module; and generating a preference matrix by modelling the supplied item preferences and item characteristics.

In one aspect, one or more items are rated multiple times by different users associated with the same group identifier.

In another aspect, an average weighting value is calculated for each item based on a plurality of supplied preference values.

In one exemplary arrangement, the number of users associated with each group is estimated. Alternatively, the number of users associated with each group is calculated.

In another aspect, each user performs self-profiling using their locally stored private preferences and selects a group identifier based on their self-profile.

In one aspect, a matrix factorisation algorithm is applied by the system module to determine a pair of matrices Ũ and V such that Ũ^{T}V is an approximation of the preference matrix.

In another aspect, one or more users select alternative group identifiers thereby changing which group they are associated with.

In one aspect, each user maintains a local copy of each supplied item preference which is kept private from the system module.

In another aspect, prior to a user supplying an item preference the user selects an optimum group based on the user's historical preferences.

In one aspect, users can select alternative groups than those initially selected in order to improve accuracy.

In an exemplary aspect, the preference matrix is updated at predetermined time periods.

In one aspect, the preference matrix is updated in real-time.

In another aspect, a minimum threshold number of users is set for each group.

In one aspect, if the number of users associated to a particular group falls below the minimum threshold number the group is deleted.

In another aspect, a maximum threshold number of users is set for each group.

In one aspect, if the number of users associated to a particular group exceeds the maximum threshold number the group is divided into one or more sub-groups.

In another aspect, each sub-group has an associated group identifier.

In one aspect, at least some of the users update their group selection.

In an exemplary aspect, if a user changes to a different group the historical preferences of the user are maintained in the previous group.

In one aspect, any preferences supplied by a user after a group change are entered into the new group.

In another aspect, each user selects a single group.

In one aspect, at least some of the users select two or more groups.

In a further aspect, if a user selects multiple groups the user weights each selected group according to a scale.

In one aspect, users supply the item preferences to the system module via the internet.

In another aspect, the user modules are configured to allow users to update their group selection via the internet.

In a further aspect, item preferences have an associated weight.

In one aspect, the weights associated with the item preferences are modifiable.

In another aspect, the weights associated with item preferences varies based on a time scale.

In one aspect, the weights associated with item preferences reduces based on the amount of elapsed time since a user supplied the initial item preference.

In a further aspect, users supply one or more false item preferences to enhance user privacy.

In another aspect, users select non-optimum groups to enhance user privacy.

In a further aspect, users change their group from an optimum group to a non-optimum to conceal the users preferences.

In one aspect, one or more additional groups are generated.

In another aspect, one or more existing groups are deleted.

In a further aspect, the users modules comprise a software application.

The present disclosure also relates to a recommender system comprising: a system module configured to generate a plurality of user groups and associate each user group with a group identifier; a plurality of user modules for facilitating users selecting one or more group identifiers indicative of the groups that the users desire to be associated with; the user modules being configured to allow users supply item preferences using the selected group identifiers thereby concealing identities of the users when supplying item preferences and communicating the supplied item preferences with associated selected group identifiers to the system module; and the system module being configured to generate a preference matrix by modelling the supplied item preferences and item characteristics.

Additionally, the present disclosure relates to a non-transitory computer-readable medium comprising instructions which, when executed, cause a processor to implement a method comprising: generating a plurality of user groups by a system module and associating each user group with a group identifier; providing the group identifiers to a plurality of user modules for facilitating selection by respective users; selecting at least one group identifier by the respective users indicative of the groups that the users desire to be associated with; supplying by the users item preferences using the group identifiers thereby concealing identities of the users when supplying item preferences; communicating the supplied item preferences with associated selected group identifiers to the system module; and generating a preference matrix by modelling the supplied item preferences and item characteristics.

These and other features will be better understood with reference to the followings Figures which are provided to assist in an understanding of the present teaching.

### BRIEF DESCRIPTION OF THE DRAWINGS

The present teaching will now be described with reference to the accompanying drawings in which:

FIG. 1 is graphical representation of a recommender system in accordance with the present teaching.

FIG. 2 is a graphical representation of a client device of the recommender system of FIG. 1.

FIG. 3 is a diagrammatic representation of the recommender system of FIG. 1.

FIG. 4 is a flow chart representation of a prior art matrix factorisation recommender system.

FIG. 5 is a flow chart representation of a recommender method implemented by the recommender system of FIG. 1.

FIG. 6(a) is a graph illustrating the positions in a latent space of users and user groups.

FIG. 6(b) is a graph illustrating the prediction RMSE of the recommender method in accordance with the present teaching versus a standard matrix factorisation approach.

FIG. 7 is a graph illustrating the prediction RMSE vs. missing values ratio for standard matrix factorisation and for the recommender method in accordance with the present teaching.

FIG. 8 is a graph illustrating prediction RMSE with Gaussian noise present.

FIG. 9(a) is a graph illustrating the RMSE of the prediction error vs the number of groups used.

FIG. 9(b) is a graphical representation of the preferences of the 10 most common rated items of Jester dataset for a 16-groups factorisation.

### DETAILED DESCRIPTION OF THE DRAWINGS

The present teaching will now be described with reference to an exemplary recommender system. It will be understood that the exemplary system is provided to assist in an understanding of the present teaching and is not to be construed as limiting in any fashion. Furthermore, modules or elements that are described with reference to any one Figure may be interchanged with those of other Figures or other equivalent elements without departing from the spirit of the present teaching.

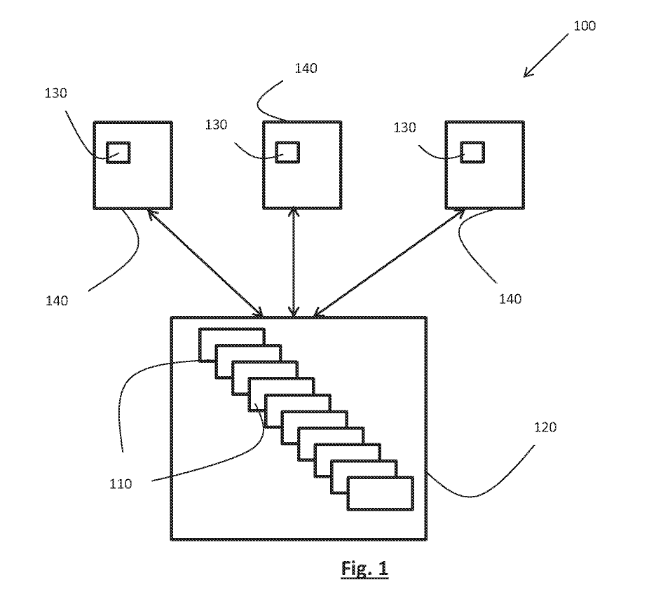

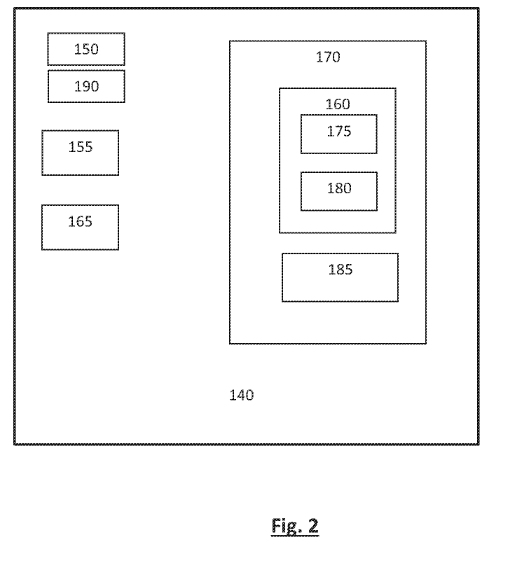

Referring initially to FIGS. 1 and 2, there is illustrated a recommender system 100 in accordance with the present teaching. A plurality of pseudo-identities or groups 110 are generated by a system module 120 which associates each group with a group identifier. The group identifiers are provided to a plurality of user modules 130 running on client devices 140. Each user maintains a local copy of each supplied item preference on their user module 130 which is kept private from the system module 120. Each user performs self-profiling via the user module 130 operating on their client device 140 using their locally stored private preferences and selects a group identifier based on their self-profile. Advantageously, users can select alternative groups than those initially selected in order to improve accuracy. Item preferences are then communicated from the client devices 140 to the system module 120 using the associated selected group identifiers. Thus, the item recommendations provided by users are tagged with a group identified selected by the user via the user modules 130.

A single group may be shared by multiple users and the number of groups available is significantly lower than the number of users. Hence tracking of group activity does not reveal the activity of individual users. Selection by users of which group to use is performed privately on their own device 140, and so does not require the release of personally identifying information.

To provide a degree of backward compatibility with existing web systems, a web cookie may be used as a group identifier i.e. existing systems for use of cookies/identifiers and rating of items may be retained with only minor modification. Note however that the group approach differs from existing single user approaches in three key aspects. Firstly, the same group identifier/cookie is shared by multiple users and so each item may be rated multiple times. Secondly, a user does not necessarily use the same group identifier for all ratings, but may use different groups as time evolves. Thirdly, each group may be shared by a different number of users and it is necessary to take this into account when making recommendations e.g. it may be important that predictions are more accurate for a group shared by many users than for one shared by few users.

The system module 120 may reside on a server or over a distributed network of devices. The system module 120 allows one or more items to be rated multiple times by different users associated with the same group identifier. The system module 120 also allows users to select alternative group identifiers thereby changing which group 110 they are associated with. The system module 120 calculates an average preference value for a (group, item) pair based on a plurality of supplied (group, item, preference) values. The number of users sharing each group is also estimated or calculated. The system module 120 applies a matrix factorisation algorithm to determine a pair of matrices Ũ and V such that Ũ^{T}V is an approximation of the matrix of supplied (group, item) preferences. The system module 120 is configured to update Ũ and V at predetermined time intervals.

FIG. 2 is a block diagram illustrating a configuration of the client device 140 which is a smart phone in the exemplary embodiment. The client device 140 includes various hardware and software components that function to perform the methods according to the present disclosure. The client device 140 can be used by users to provide online item recommendations. The client device 140 comprises a user interface 150, a processor 155 in communication with a memory 160, and a communication interface 165. The processor 155 functions to execute software instructions that can be loaded and stored in the memory 160. The processor 155 may include a number of processors, a multi-processor core, or some other type of processor, depending on the particular implementation. The memory 160 may be accessible by the processor 155, thereby enabling the processor 155 to receive and execute instructions stored on the memory 160. The memory 160 may be, for example, a random access memory (RAM) or any other suitable volatile or non-volatile computer readable storage medium. In addition, the memory 160 may be fixed or removable and may contain one or more components or devices such as a hard drive, a flash memory, a rewritable optical disk, a rewritable magnetic tape, or some combination of the above.

One or more software modules 170 may be encoded in the memory 160. The software modules 170 may comprise one or more software programs or applications having computer program code or a set of instructions configured to be executed by the processor 155. Such computer program code or instructions for carrying out operations for aspects of the systems and methods disclosed herein may be written in any combination of one or more programming languages.

The software modules 170 may include a recommender app 175 and one or more social media apps 180 configured to be executed by the processor 155. The recommender app 175 may comprise the user module 130 as described above. The recommender app 175 may have functionality and capability to interact with social media applications. During execution of the software modules 170, the processor 155 configures the client device 140 to perform various operations relating to the facilitating and processing of item recommendations according to embodiments of the present disclosure.

Other information and/or data relevant to the operation of the present systems and methods, such as a database 185, may also be stored on the memory 160. The database 185 may contain and/or maintain various data items and elements that are utilized throughout the various operations of the recommender system 100. The information stored in the database 185 may include but is not limited to, records of previous item preferences provided by the respective users. It should be noted that although the database 185 is depicted as being configured locally to the client device 140, in certain implementations the database 185 and/or various other data elements stored therein may be located remotely. Such elements may be located on a remote device or server—not shown, and connected to the client device 140 through a network in a manner known to those skilled in the art, in order to be loaded into a processor and executed.

Further, the program code of the software modules 170 and one or more computer readable storage devices (such as the memory 160) form a computer program product that may be manufactured and/or distributed in accordance with the present disclosure, as is known to those of skill in the art.

The communication interface 165 is also operatively connected to the processor 155 and may be any interface that enables communication between the client device 140 and external devices, machines and/or elements including a server on which the system module 120 resides. The communication interface 165 is configured for transmitting and/or receiving data. For example, the communication interface 165 may include but is not limited to a Bluetooth, or cellular transceiver, a satellite communication transmitter/receiver, an optical port and/or any other such, interfaces for wirelessly connecting the client device 140 to the system module 120.

The user interface 150 is also operatively connected to the processor 155. The user interface may comprise one or more input device(s) such as switch(es), button(s), key(s), and a touchscreen. The user interface 110 functions to allow the entry of item recommendations and selecting a group identifier from a list of group identifiers. The user interface 150 functions to facilitate the capture of commands from the user such as an on-off commands or settings related to operation of the above-described method.

A display 190 may also be operatively connected to the processor 155. The display 190 may include a screen or any other such presentation device that enables the user to view various options, parameters, and results, such as the group identifiers. The display 190 may be a digital display such as an LED display. The user interface 150 and the display 190 may be integrated into a touch screen display. The operation of the client device 140 and the various elements and components described above will be understood by those skilled in the art with reference to the method and system for providing item recommendations

It will therefore be appreciated that the recommender system 100 may comprise a system module 120 configured to generate a plurality of user groups 110 and associate each user group with a group identifier. A plurality of user modules 130 are provided for facilitating users selecting one or more group identifiers indicative of the groups that the users desire to be associated with. The user modules 130 are configured to allow users supply item preferences using the selected group identifiers thereby concealing identities of the users when supplying item preferences and communicating the supplied item preferences with associated selected group identifiers to the system module 120. The system module 120 may be configured to generate a preference matrix by modelling the supplied item preferences and item characteristics.

Furthermore, it will be appreciated that a non-transitory computer-readable medium may be provided which includes instructions which, when executed, cause a processor to implement a method comprising generating a plurality of user groups by a system module and associating each user group with a group identifier; providing the group identifiers to a plurality of user modules for facilitating selection by respective users; selecting at least one group identifier by the respective users indicative of the groups that the users desire to be associated with; supplying by the users item preferences using the group identifiers thereby concealing identities of the users when supplying item preferences; communicating the supplied item preferences with associated selected group identifiers to the system module; and generating a preference matrix by modelling the supplied item preferences and item characteristics.

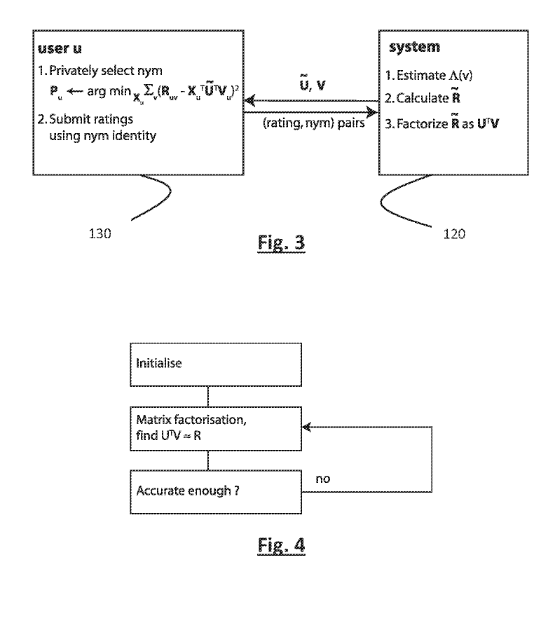

An exemplary setup of the recommender system 100 is illustrated in FIG. 3. Each user keeps their own local copy of the ratings given so far. This copy is private, and is never disclosed beyond the user's client device 140. The rating by user u of item v is denoted by Rᵤᵥ in FIG. 3. When accessing the system module 120, a user determines the group 110 which is currently “closest” to them and uses this when interacting with the system 120. It does this by solving a least-squares optimisation. Namely from the set of px1 vectors which have all zero elements apart from one element with value 1, the users selects that vector Xᵤ which minimises the function shown in FIG. 3. The single non-zero element in Xᵤ indicates the group identifier to use. The user ratings are then submitted to the system 120 using the group identifier (denoted by “nym” in FIG. 3). In addition to use of cookies as group identifiers, many existing systems require user login. This would again uniquely identify the user. However, the present inventors envisage that the recommender system 120 would allow use of an anonymous login by users, shared by users of the system 120.

Instead of always using the approach described above to select the “closest” group, other approaches are also possible. For example, users could sometimes use another group 110 so as to make it harder for an adversary to estimate which group 110 they prefer. Users might also submit “noisy” or false ratings so as to further obscure their true interests. This type of approach is compatible with differential privacy. Users might also restrict themselves to use of groups shared by at least k other users and in this way gain a form of k anonymity.

The system 120 receives item ratings tagged with a group identifier. For each group g and item v for which ratings have been supplied, the system estimates the number of users sharing that group and constructs a diagonal matrix Λ(ν) with these estimates on the diagonal. It then selects matrices U and V so as to maximise

$$log \tilde{p} ( \tilde{U} , V \vert {ℛ}_{O} ; P ) = - \frac{1}{{σ}^{2 }} {\sum }_{v ∈ 𝒱} {( {\tilde{R}}_{v} - {\tilde{U}}^{T} {V}_{v} )}^{T} Λ ( v ) ( {\tilde{R}}_{v} - {\tilde{U}}^{T} {V}_{v} ) - \frac{1}{{σ}_{U}^{2}} tr {\tilde{U}}^{T} \tilde{U} - \frac{1}{{σ}_{V}^{2}} {trV}^{T} V \qquad ( 3 )$$

where V is the set of items which have been rated, σ, σ_{Ũ}, σ_{V} are design parameters and \tilde{R} is a matrix with element (g,v) equal to the average rating of element v by group g i.e. the sum of the supplied ratings of v by g divided by the number of ratings supplied. Note that \tilde{R}ᵥ denotes the v'th column of matrix \tilde{R} and similarly Vᵥ.

The algorithm of the overall recommender system 100 in accordance with the present teaching may be expressed as follows:

Algorithm 1 BLC Nym Recommender

```
loop
  Initialise E, Δ ← ∞, Ū ← [symbol]  (0, σ), V ← [symbol]  (0, σ)
  while EΔ > ε do {Block 1. System factorisation}
    for g = 1, . . . , p do
      if Σ_{v∈V}Λ(v)_{gg} > 0 then
      ${\tilde{U}}_{g}^{T} ← {\sum }_{v ∈ V} {Λ ( v )}_{gg} {\tilde{R}}_{gv} {{V}_{u}^{T} ( \frac{{σ}^{2}}{{σ}_{\hat{U}}^{3}} I + {\sum }_{w ∈ V} {Λ ( w )}_{gg} {V}_{w} {V}_{w}^{T} )}^{- 1}$
      end if
    end for
    for all v ∈ V do
      ${V}_{v}^{T} ← {\tilde{R}}_{v}^{T} Λ ( v ) {{\tilde{U}}^{T} ( \frac{{σ}^{2}}{{σ}_{V}^{3}} I + \tilde{U} Λ ( v ) {\tilde{U}}^{T} )}^{- 1}$
    end for
    Ê ← log \tilde{p}(Ū, V|R_{O}; P)
    Δ ← |Ê − E|, E ← E
  end while
  for all u ∈ U do [Block 2. User private nym choice]
    Pᵤ ← minₓ_{ᵤ}_{∈I} Σ_{v∈V(u)}(Rᵤᵥ − Xᵤ^{T}Ũ^{T} Vᵥ)²
    for all v ∈ V(u) do
      Λ(v) = Σ_{u∈U(v)} PᵤPᵤ^{T}
    end for
    \tilde{R}ᵥ = Λ⁻¹(v) Σ_{u∈U(v)} RᵤᵥPᵤ∀v ∈ V
  end for
end loop
```

It will be appreciated by those skilled in the art that the algorithm may be expressed using alternative expressions to those listed above which is provided by way of example only.

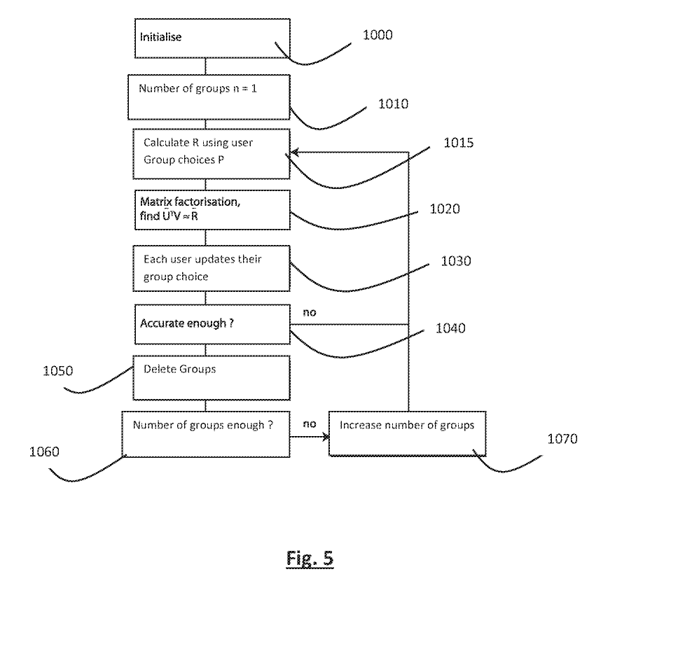

Referring now to FIG. 4 which illustrates how a typical matrix factorisation recommender systems operates. Given rating matrix R where entry Rᵢⱼ is the rating by user i of item j, standard algorithms are used to find a pair of matrices U and V such that U^{T}V is a good approximation to R. Typical algorithms for carrying out this matrix factorisation include sequential least squares and gradient descent. The flow chart of FIG. 5 graphically illustrates the steps of the algorithm of the recommender system 100. Matrix factorization is used as a building block, but the approach is extended to allow groups to be detected within the users. The recommender system 100 is initialised, step 1000. The best choice for the number n of groups needs to be selected, and to do this the system starts with n=1, step 1010. The group rating matrix \tilde{R} is calculated, step 1015, the system then finds the best prediction of the user ratings, step 1020, each user updates their choice of group needed, step 1030, any unused groups are removed, step 1050, and one or more additional groups 110 may be generated by the system (n is increased) as needed, step 1070. Using this assignment, step 1020. The process repeats until the user ratings are predicted with sufficient accuracy.

A minimum threshold number of users may be set for each group 110. If the number of users associated to a particular group 110 falls below the minimum threshold number the group may be deleted, 150. A maximum threshold number of users may also be set for each group. If the number of users associated to a particular group exceeds the maximum threshold number the group is divided into one or more sub-groups or additional groups 110 are added, step 1060. Each sub-group may have an associated group identifier.

Each user may select a single group or multiple groups. If a user selects multiple groups the user may weight each selected group according to a scale.

Users may update their group selection as time evolves, step 1030. If a user changes to a different group the historical preferences of the user may be maintained in the previous group. Item preferences may have an associated weight. The weights associated with the item preferences are modifiable. For example, the weights associated with item preferences may reduce based on the amount of elapsed time since a user supplied the item preference.

In order to further enhance privacy, users may supply one or more false item preferences. Users may choose non-optimum groups to enhance user privacy. For example, users may change their group from an optimum group to a non-optimum to conceal the users preferences.

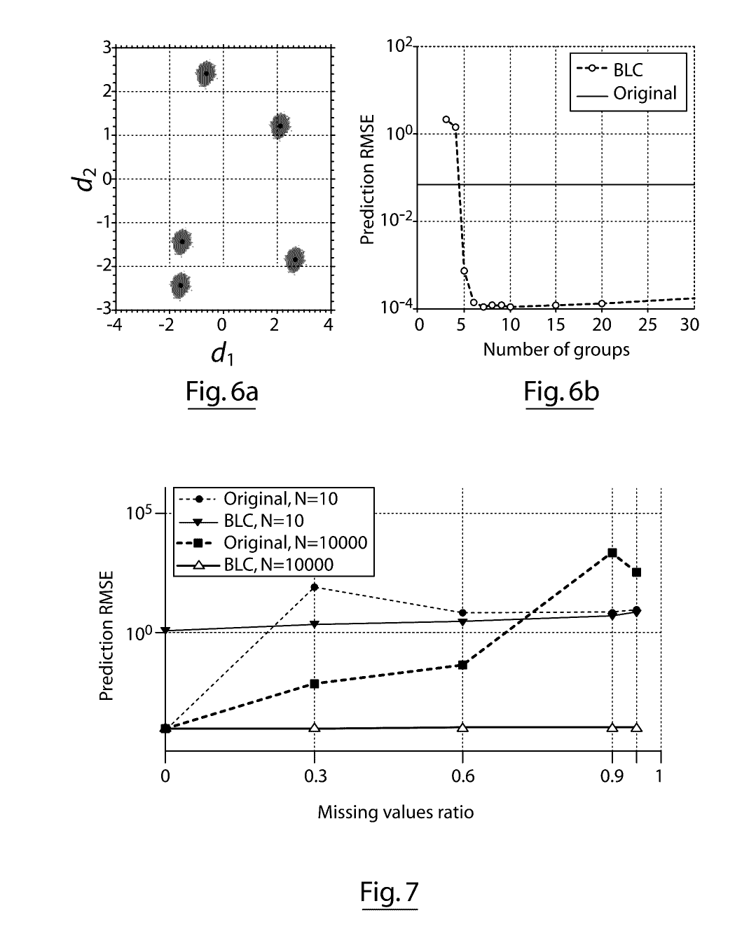

In the example of FIG. 6, a tailored synthetic data scenario was created with m=100 items and a variable number of users n in the range [10; 1000]. The system generated 5 user groups, by i) selecting 5 points in the feature space d=4 dimensional latent space) as “group centres”, and ii) randomly drawing the n simulated users in a Gaussian neighbour of the selected group centres. For example, with a standard deviation equal to 0.01, users would be strongly clustered as graphically illustrated in FIG. 6a. The system then built a rating matrix R, randomly removing entries to reach a desired sparsity degree.

FIG. 6b evaluates the prediction Root Mean Square Error (RMSE) for the enhanced recommender method versus the number of groups used. These results are with 10 000 users and 50% of missing values and Gaussian noise with very low standard deviation, 10⁻⁴. As the figure shows, once at least 5 groups are employed, the enhanced recommender method properly learns the user groups 110 and consistently outperforms the standard matrix factorisation approach.

FIG. 7 analyses the impact on performance of missing ratings and the number of users. The figure shows the prediction RMSE versus the fraction of missing values for the standard matrix factorisation approach, for different numbers of users. The prediction performance of the standard approach degrades as the fraction of missing values increases; besides, this is consistent as the number of users varies. Conversely, the enhanced recommender method exhibits an excellent performance for 10 000 users, with prediction RMSE insensitive to the fraction of missing values until this fraction reaches 95%. This is important as it means that the system is able to make useful recommendations with only a small amount of user rating data by exploiting the learnt group structure of the users. Performance remains good even if the number of users drops to the order of 100, and impairments appear only when a very small number of users are used.

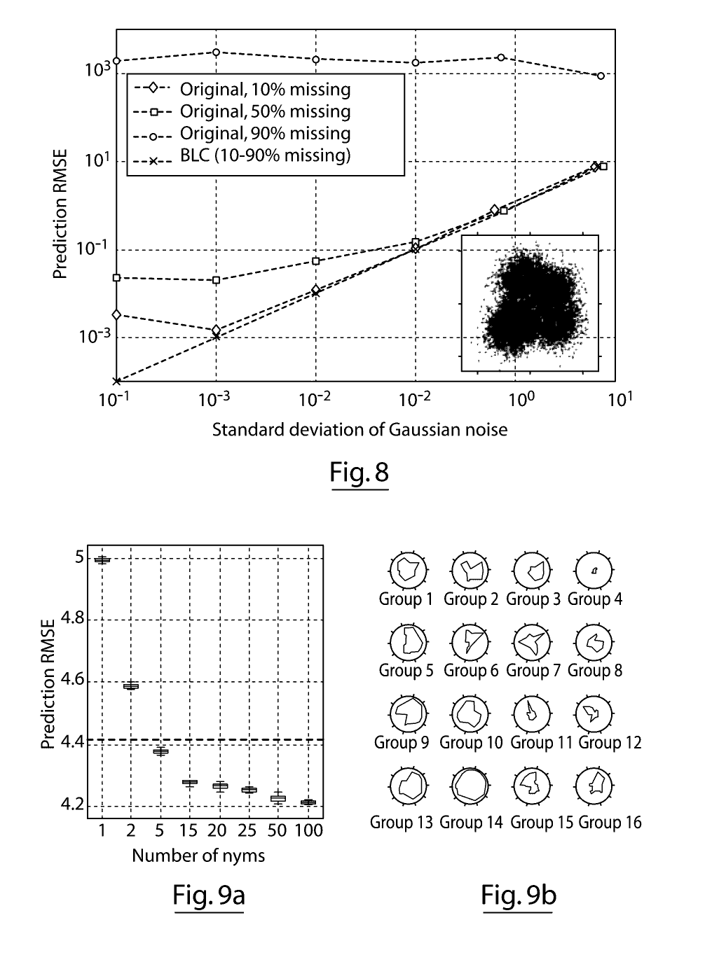

Gaussian noise may be used to generate the users around the 5 chosen groups, i.e., by spreading the users away from the originally chosen group centres. FIG. 8 shows the prediction RMSE versus the noise intensity, for a setup with 10 000 users and different numbers of missing ratings. It may be seen that for the proposed group method the missing rating ratio hardly affects the prediction performance, while for large values of this parameter the original matrix factorisation performs poorly. It can be seen that there is a linear relationship between the added noise and the RMSE, indicating that the group learning approach is robust to noise and is able to find a minimally noisy (in the sense of RMSE) predictions, while for the original matrix factorisation the prediction error is higher for small values of noise.

The recommender system 100 was tested using the Jester dataset, which consists of 1,801,455 ratings 24 983 users of 100 items. To ensure a fair comparison, the regularisation parameters of the original matrix factorisation algorithm are optimised using a standard bisection search. The prediction is computed by cross validation using 10% of the dataset as a test set. FIG. 9a presents the RMSE of the prediction error versus the number of groups used. It can be seen that for 5 or more groups, the method in accordance with the present teaching achieves better prediction accuracy than the original matrix factorisation approach. FIG. 9b provides a graphical of the preferences of the 10 most common rated items of Jester dataset for a 16-groups factorisation is provided.

It will be understood that what has been described herein is an exemplary recommender system. While the present teaching has been described with reference to exemplary arrangements it will be understood that it is not intended to limit the teaching to such arrangements as modifications can be made without departing from the spirit and scope of the present teaching.

It will be understood that while exemplary features of a recommender system in accordance with the present teaching have been described that such an arrangement is not to be construed as limiting the invention to such features. The algorithm of the recommender system may be implemented in software, firmware, hardware, or a combination thereof. In one mode, the algorithm is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the algorithm may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the algorithm as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the algorithm and is executable on a suitable operating system (O/S).

The present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the algorithm is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the algorithm, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims.

While the present teaching has been described with reference to exemplary applications and modules it will be understood that it is not intended to limit the teaching of the present teaching to such arrangements as modifications can be made without departing from the spirit and scope of the present invention. It will be appreciated that the system may be implemented using cloud or local server architecture. In this way it will be understood that the present teaching is to be limited only insofar as is deemed necessary in the light of the appended claims.

Similarly the words comprises/comprising when used in the specification are used to specify the presence of stated features, integers, steps or components but do not preclude the presence or addition of one or more additional features, integers, steps, components or groups thereof.

1. A computer implemented method for providing item recommendations, the method comprising:
generating a plurality of user groups by a system module and associating each user group with a group identifier;
providing the group identifiers to a plurality of user modules for facilitating selection by respective users;
selecting at least one group identifier by the respective users indicative of the one or more groups that users desire to be associated with;
supplying by the users item preferences using the selected group identifier thereby concealing identities of the users when supplying item preferences;
communicating the supplied item preferences with associated selected group identifiers to the system module; and
generating a preference matrix by modelling the supplied item preferences and item characteristics.

2. A method as claimed in claim 1, wherein one or more items are rated multiple times by different users associated with the same group identifier.

3. A method as claimed in claim 1, wherein an average weighting value is calculated for each item based on a plurality of supplied preference values.

4. A method as claimed in claim 1, wherein the number of users associated with each group is estimated.

5. A method as claimed in claim 1, wherein the number of users associated with each group is calculated.

6. A method as claimed in claim 1, wherein each user performs self-profiling using their locally stored private preferences and selects a group identifier based on their self-profile.

7. A method as claimed in claim 1, wherein a matrix factorisation algorithm is applied by the system module to determine a pair of matrices Ũ and V such that Ũ^{T}V is an approximation of the preference matrix.

8. A method as claimed in claim 1, wherein one or more users select alternative group identifiers thereby changing which group they are associated with.

9. A method as claimed in claim 1, wherein each user maintains a local copy of each supplied item preference which is kept private from the system module.

10. A method as claimed in claim 9, wherein prior to a user supplying an item preference the user selects an optimum group based on the user's historical preferences.

11. A method as claimed in claim 7, wherein users can select alternative groups than those initially selected in order to improve accuracy.

12. A method as claimed in claim 11, wherein the preference matrix is updated at predetermined time periods.

13. A method as claimed in claim 12, wherein the preference matrix is updated in real-time.

14. A method as claimed in claim 1, wherein a minimum threshold number of users is set for each group.

15. A method as claimed in claim 14, wherein if the number of users associated to a particular group falls below the minimum threshold number the group is deleted.

16. A method as claimed in claim 1, wherein a maximum threshold number of users is set for each group.

17. A method as claimed in claim 16, wherein if the number of users associated to a particular group exceeds the maximum threshold number the group is divided into one or more sub-groups.

18. A method as claimed in claimed 17, wherein each sub-group has an associated group identifier.

19. A method as claimed in claim 1, wherein at least some of the users update their group selection.

20. A method as claimed in claim 19, wherein if a user changes to a different group the historical preferences of the user are maintained in the previous group.

21. A method as claimed in claim 19, wherein any preferences supplied by a user after a group change are entered into the new group.

22. A method as claimed in claim 1, wherein each user selects a single group.

23. A method as claimed in claim 1, wherein at least some of the users select two or more groups.

24. A method as claimed in claim 23, wherein if a user selects multiple groups the user weights each selected group according to a scale.

25. A method as claimed in claim 24, wherein the user modules are configured to allow users to update their item preferences and/or group selection via the internet.

26. A method as claimed in claim 1, wherein item preferences have an associated weight.

27. A method as claimed in claim 26, wherein the weights associated with the item preferences are modifiable.

28. A method as claimed in claim 27, wherein the weights associated with item preferences varies based on a time scale.

29. A method as claimed in claim 28, wherein the weights associated with item preferences reduces based on the amount of elapsed time since a user supplied the initial item preference.

30. A method as claimed in claim 1, wherein users supply one or more false item preferences to enhance user privacy.

31. A method as claimed in claim 1, wherein users select non-optimum groups to enhance user privacy.

32. A method as claimed in claim 1, wherein users change their group from an optimum group to a non-optimum to conceal the users preferences.

33. A method as claimed in claim 1, wherein one or more additional groups are generated.

34. A method as claimed in claim 1, wherein one or more existing groups are deleted.

35. A method as claimed in claim 1, wherein the users modules comprise a software application.

36. A recommender system comprising:
a system module configured to generate a plurality of user groups and associate each user group with a group identifier;
a plurality of user modules for facilitating users selecting one or more group identifiers indicative of the groups that the users desire to be associated with; the user modules being configured to allow users supply item preferences using the selected group identifiers thereby concealing identities of the users when supplying item preferences and communicating the supplied item preferences with associated selected group identifiers to the system module; and the system module being configured to generate a preference matrix by modelling the supplied item preferences and item characteristics.

37. A non-transitory computer-readable medium comprising instructions which, when executed, cause a processor to implement a method comprising:
generating a plurality of user groups by a system module and associating each user group with a group identifier;
providing the group identifiers to a plurality of user modules for facilitating selection by respective users;
selecting at least one group identifier by the respective users indicative of the groups that the users desire to be associated with;
supplying by the users item preferences using the group identifiers thereby concealing identities of the users when supplying item preferences;
communicating the supplied item preferences with associated selected group identifiers to the system module; and
generating a preference matrix by modelling the supplied item preferences and item characteristics.
